(19) United States
(12) Patent Application Publication
(10) Pub. No.: US 2026/0264204 A1
(43) Pub. Date: Sep. 10, 2026

(54) TORSION SPRING TENSIONING TOOL

(71) Applicant: Assa Abloy Entrance Systems AB, Landskrona (SE)

(72) Inventors: Bert VAN DEN HAZEL, Putten (NL); Toby BOETERS, Amersfoort (NL); Paul WENSING, Woudenberg (NL)

(21) Appl. No.: 19/167,902

(22) PCT Filed: Mar. 26, 2024
(86) PCT No.: PCT/EP2024/058147

§ 371 Date: Sep. 23, 2025

(30) Foreign Application Priority Data
Mar. 28, 2023 (SE) 2330138-5

(51) Int. Cl. B25B 27/30

(52) U.S. Cl. CPC B25B 27/306

(57) ABSTRACT

ASSA ABLOY Entrance Systems AB has developed torsion spring tensioning tool (100 ) for tensioning a torsion spring of a counterbalancing mechanism of an overhead door, wherein the torsion spring tensioning tool (100) comprises a housing (80), a gear wheel arrangement (20) adapted to be mounted on a shaft (1001) of the counterbalancing mechanism, said gear wheel arrangement (20) comprising a gear wheel (21) rotatably arranged in the housing (80), the torsion spring tensioning tool (100) further comprising a gear mechanism (54) coupled to the gear wheel (21) for rotating said gear wheel (21). The torsion spring tensioning tool (100) further comprises a gripping arrangement (300) adapted to releasably engage the shaft (1001) of the counterbalancing mechanism by means of gripping said shaft (1001) of the counterbalancing mechanism.

### TECHNICAL FIELD

Present invention relates to a torsion spring tensioning tool for tensioning a torsion spring of a counterbalancing mechanism of an overhead door.

### BACKGROUND

In overhead doors, a counterbalancing mechanism is usually used to counterbalance the weight of the door in order to reduce the force required for operating the door. This reduces the human effort or the motor power required to open the door.

The counterbalancing mechanism usually comprises one or two torsion springs arranged around a shaft. One end of the torsion spring is fixed e.g. by a stationary cone. The other end of the torsion spring usually comprises a winding cone that is securable to the shaft by tightening screws and sometimes by a key. The winding cone is commonly provided with four radial holes for winding of the spring either by hand operated rods or by a tensioning tool for tensioning of the spring by rotation of the torsion spring before securing the winding cone to the shaft. In some cases the winding cone may be provided with a set of splines for the same purpose.

One type of tensioning tool is described in U.S. Pat. No. 8,616,093, where a torsion spring winding assembly comprises a coupling shaft structure for installation on a torsion spring winding cone, a gearbox assembly installed onto the coupling shaft structure and a sliding lever arm attached to the gearbox assembly and positioned against the inside of a garage door frame structure. The coupling shaft structure is comprised of two body halves fitted together by guiding pins and mating holes. Each body half has a winding hub portion. Each winding hub portion has two locking bolts hand tightened into winding bar slots on the winding cone. The gearbox assembly has a gearbox end cap that is pivotable into an open position. The gearbox end cap fits around the coupling shaft structure. The gearbox assembly is securable to the coupling shaft structure. A screw gun applies a rotational force to the gearbox assembly. Known tensioning tools are complicated to mount on the shaft of the counterbalancing mechanism and require a large number of operations to connect the tensioning tool to the torsion spring.

There are tools available on the market; however, such tools are not very robust relative to the high torque of the torsion spring. Tensioning tools according to prior art also comprises several parts that are complex, weak and sensitive to wear.

In order to address the above referenced issues a torque tensioning tool involving the use of different adapters for allowing service personnel to service different brands and types of door a new torque tool was developed. The torque tool is disclosed in WO 2022117574 A1. The present inventors have however identified that the mounting of such adapters is cumbersome and makes the torque tool more complex to use as well as bulkier which may prevent tensioning of the torsion spring if there is limited room available next to the door. Furthermore, the present inventors have identified that a more safe tensioning tool is desirable.

Thus, there exists a need for an improved tensioning tool.

### SUMMARY

According to an aspect, a torsion spring tensioning tool for tensioning a torsion spring of a counterbalancing mechanism of an overhead door is provided. The torsion spring tensioning tool comprises a housing and a gear wheel arrangement adapted to be mounted on a shaft of the counterbalancing mechanism. The gear wheel arrangement comprises gear wheel rotatably arranged in the housing.

The torsion spring tensioning tool further comprises a gear mechanism coupled to the gear wheel for rotating said gear wheel. The gear wheel arrangement comprises an engaging arrangement. The engaging arrangement is arranged to be fixed relative to the gear wheel.

The engaging arrangement is adapted to engage the shaft of the counterbalancing mechanism. The engaging arrangement is adapted to transmit a rotational movement from the gear wheel to the torsion spring.

The torsion spring tensioning tool further comprises a gripping arrangement adapted to releasably engage the shaft of the counterbalancing mechanism by means of gripping said shaft of the counterbalancing mechanism.

The torsion spring tensioning tool mitigates the risk for the torsion spring tensioning tool disengages the shaft during tensioning. Furthermore, it allows for a safer torsion spring tensioning tool which can be used in relatively tight spaces due to providing a space-efficient manner of securing the torsion spring tensioning tool to the shaft.

According to an aspect, a torsion spring tensioning tool kit is provided. The torsion spring tensioning tool kit comprises a torsion spring tensioning tool. The torsion tensioning tool kit further comprises one or more adapter units. The one or more adapter units are adapted to alter or at least partially replace the clamping device of the torsion spring tensioning tool to accommodate clamping of different types of powered torque tools.

According to an aspect, a torsion spring tensioning tool system is provided. The torsion spring tensioning tool kit comprises a torsion spring tensioning tool. The torsion spring tensioning tool system further comprises a powered torque tool.

Embodiments of the invention are defined by the appended dependent claims and are further explained in the detailed description section as well as in the drawings.

It should be emphasized that the term “comprises/comprising” when used in this specification is taken to specify the presence of stated features, integers, steps, or components, but does not preclude the presence or addition of one or more other features, integers, steps, components, or groups thereof. All terms used in the claims are to be interpreted according to their ordinary meaning in the technical field, unless explicitly defined otherwise herein. All references to “a/an/the [element, device, component, means, step, etc.]” are to be interpreted openly as referring to at least one instance of the element, device, component, means, step, etc., unless explicitly stated otherwise. The steps of any method disclosed herein do not have to be performed in the exact order disclosed, unless explicitly stated.

### BRIEF DESCRIPTION OF DRAWINGS

Embodiments of the invention will be described in the following; reference being made appended drawings which illustrate non-limiting examples of how the inventive concept can be reduced into practice.

FIG. 1 depicts a torsion spring tensioning tool according to one embodiment in a perspective view.

FIG. 2 depicts a portion of the torsion spring tensioning tool according to one embodiment with a portion of the housing removed in a perspective view.

FIG. 3 depicts a portion of the torsion spring tensioning tool according to one embodiment in a perspective view.

FIG. 4 depicts a portion of the torsion spring tensioning tool according to one embodiment in a perspective view.

FIG. 5 depicts a torsion spring tensioning tool according to one embodiment in a perspective view.

FIG. 6 depicts a torsion spring tensioning tool according to one embodiment in a perspective view.

FIG. 7a-b depicts a torsion spring tensioning tool according to one embodiment connected to a shaft of a counterbalancing mechanism.

FIG. 8 depicts a torsion spring tensioning tool according to one embodiment with a portion of the housing removed in a perspective view.

FIG. 9a depicts an engaging arrangement and gripping arrangement according to one embodiment in a perspective view.

FIG. 9b depicts the engaging arrangement and gripping arrangement according to one embodiment in a perspective view.

FIG. 9c depicts the engaging arrangement and gripping arrangement according to one embodiment in a perspective view.

FIG. 9d depicts parts of the gripping arrangement according to one embodiment in a front view.

FIG. 9e depicts parts of the gripping arrangement according to one embodiment in a bottom view.

FIG. 10a depicts an engaging arrangement and gripping arrangement according to one embodiment in a perspective view.

FIG. 10b depicts the engaging arrangement and gripping arrangement according to one embodiment in a perspective view.

FIG. 10c depicts the engaging arrangement and gripping arrangement according to one embodiment in a perspective view.

FIG. 10d depicts parts of the gripping arrangement according to one embodiment in a front view.

FIG. 11a-b depicts a clamping device of a torsion spring tensioning tool according to one embodiment in a perspective view.

### DETAILED DESCRIPTION

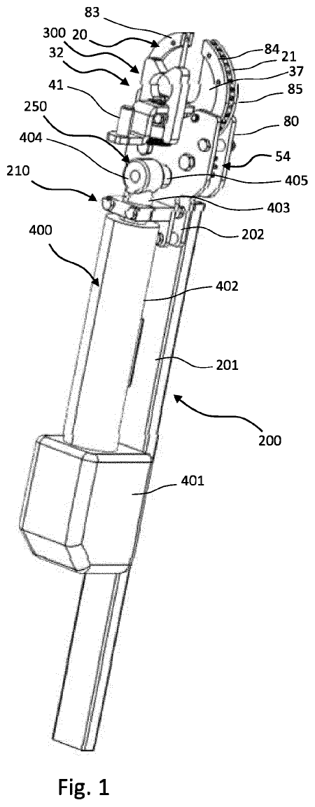

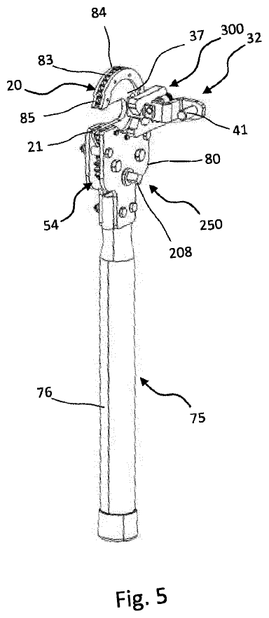

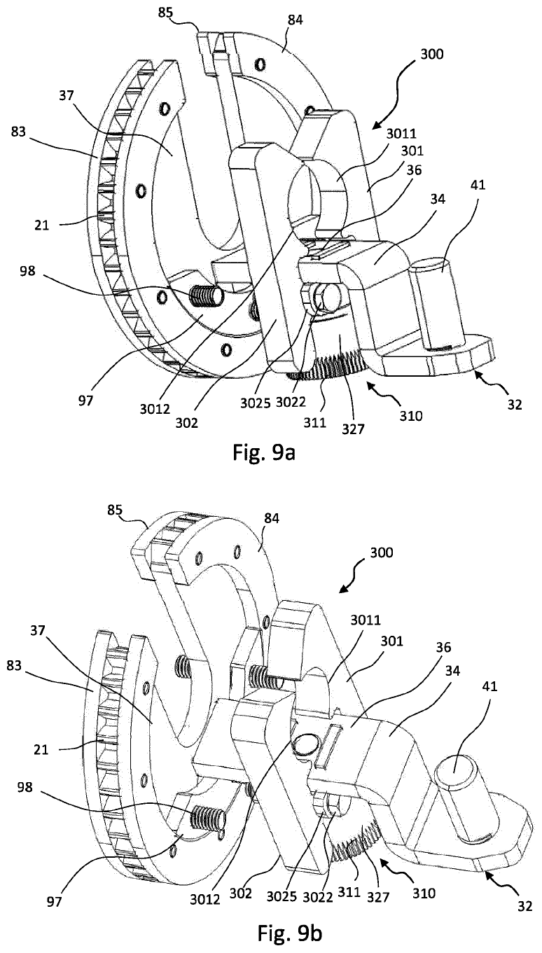

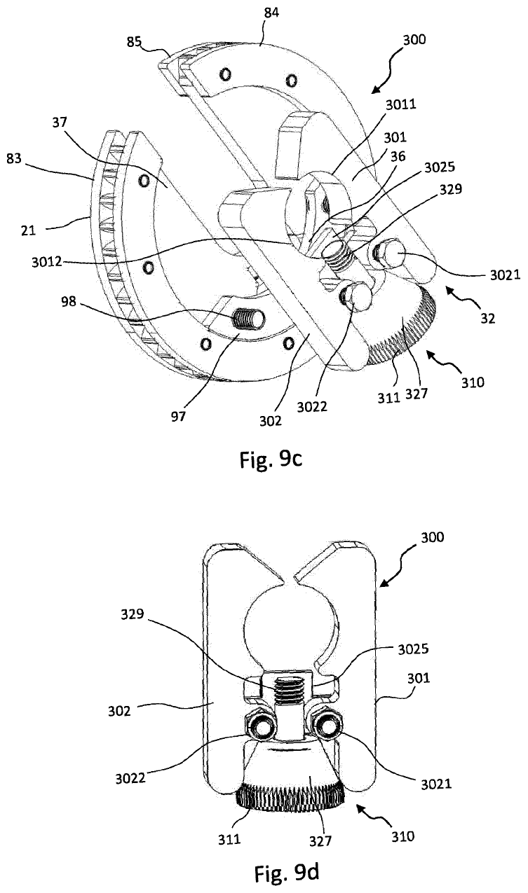

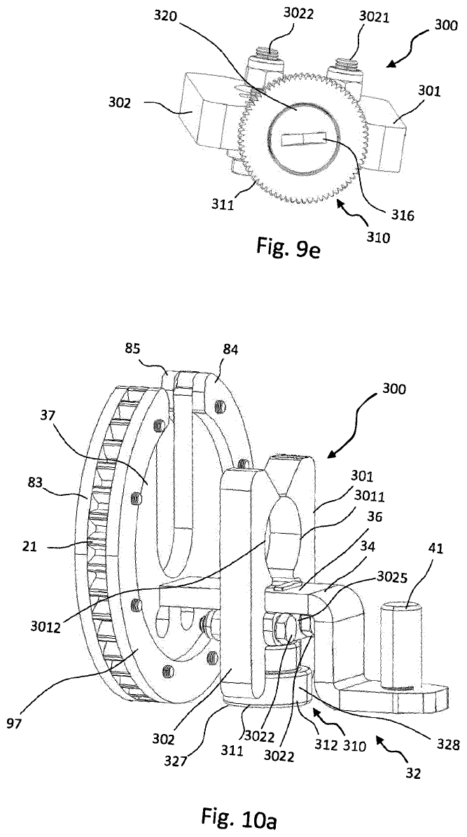

A torsion spring tensioning tool 100 for tensioning a torsion spring of a counterbalancing mechanism of an overhead door according to one embodiment is depicted in FIGS. 1-4. Torsion spring tensioning tools according to other embodiments are depicted in FIGS. 5-8. Details of the torsion spring tensioning tool according to some embodiments are depicted in FIGS. 9-11.

Referencing FIGS. 1-4, the torsion spring tensioning tool 100 comprises a housing 80 and a gear wheel arrangement 20. The gear wheel arrangement 20 is adapted to be mounted on a shaft of the counterbalancing mechanism.

The gear wheel arrangement 20 comprises a gear wheel 21. The gear wheel 21 is rotatably arranged in the housing 80.

The torsion spring tensioning tool 100 further comprises a gear mechanism 54. The gear mechanism 54 is coupled to the gear wheel 21 for rotating said gear wheel 21.

The gear wheel arrangement 20 further comprises an engaging arrangement 32. The engaging arrangement 32 is arranged to be fixed relative to the gear wheel 21. The engaging arrangement 32 may be fix relative to the gear wheel 21 by means of being mounted to the gear wheel 21. Preferably, the engaging arrangement 32 may be fix relative to the gear wheel 21.

The gear mechanism allows for tensioning of the torsion spring in a simple manner by rotation of the gear mechanism. Thus, a more safe and user friendly tensioning may be achieved.

The engaging arrangement 32 is adapted to engage the shaft of the counterbalancing mechanism and transmit a rotational movement from the gear wheel 21 to the torsion spring of the counterbalancing mechanism. In one embodiment, the engaging arrangement 32 may be adapted to engage a corresponding engagement interface of the shaft. The engaging arrangement 32 may be adapted to transmit a rotational movement from the gear wheel 21 to the torsion spring of the counterbalancing mechanism. The rotational movement accordingly provides a tensioning torque for the torsion spring.

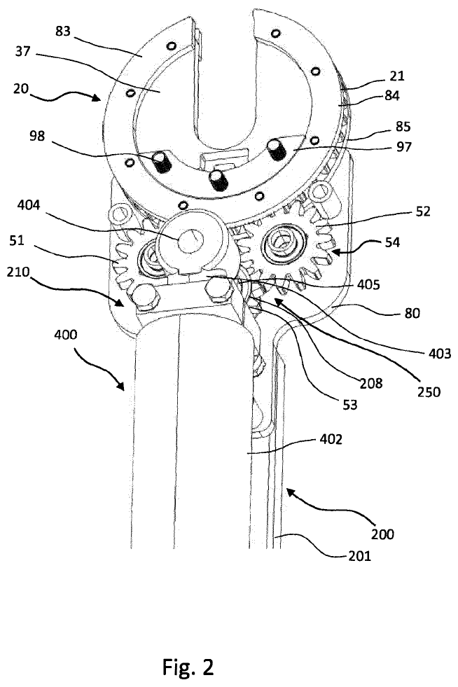

FIG. 2 depicts the torsion spring tensioning tool with a part of the housing as well as the engaging arrangement removed in order to show the components arranged inside the housing.

Referencing FIG. 2, the gear mechanism 54 may comprise a torque receiving arrangement 250. The torque receiving arrangement 250 may comprise a drivable member 208. The drivable member 208 may be adapted to be brought into engagement with a driving member 404 of a powered torque tool 400 for transfer of torque to the gear wheel 21.

Thus, the driving member 404 rotates the drivable member 208. The drivable member 208 rotates the gear wheel 21 (preferably via other gears of the gear mechanism). The gear wheel arrangement 20 with the gear wheel 21 is connected to the torsion spring by means of the engaging arrangement 32 or the second engaging arrangement 60. Thereby, the torsion spring is tensioned by the powered torque tool.

The torque tensioning tool 100 may further comprise a torque tool mounting arrangement 200. The torque tool mounting arrangement 200 may be adapted to releasably retain the powered torque tool 400.

This is associated with several technical benefits. For example, the torque tool mounting arrangement allows the operator to free one hand during the tensioning of the torsion spring due to the tool in itself holding the powered torque tool in position allowing for easier tensioning. Another technical benefit is that the torque tool mounting arrangement allows for a driven tensioning of the shaft even when the space around the door is limited.

The torque tool mounting arrangement 200 may be adapted to releasably retain the powered torque tool 400 in a position wherein the driving member 404 is engaging the drivable member 208 of the torque receiving arrangement 250.

The drivable member 208 may be in the form of a shaft portion with an engagement member for interfacing with the driving member 404. In one embodiment, the drivable member 208 may be provided on one of the gear wheels of the gear mechanism 54. The drivable member 208 may rotatably arranged. The drivable member 208 may be rotatably arranged in the housing 80. The drivable member 208 may be arranged in a bearing mounted in the housing 80.

The powered torque tool 400 may be any type of powered torque tool 400 suitable for providing a controlled torque to the torsion spring tensioning tool. In one embodiment, the powered torque tool 400 may be a powered ratchet wrench. In another embodiment, the powered torque tool 400 may be a screw gun or a drilling machine.

The driving member 404 may be a rotatable member of the powered torque tool 400 adapted to transfer the torque from a drive unit of the powered torque tool 400 to an external part such as the drivable member 208 of the torsion spring tensioning tool 100.

The powered torque tool 400 may be a battery powered torque tool. Thus, the powered torque tool 400 may comprise an electrical motor and a battery 401. The battery 401 is operatively connected to the electrical motor for powering said electrical motor. In an alternative embodiment, the powered torque tool may be a hydraulic or pneumatic powered torque tool.

The powered torque tool 400 may comprise a casing 402. The casing 402 accommodates the electrical motor of the powered torque tool. The casing 402 may further accommodate a gearbox and/or a tool shaft driven by means of the electrical motor. In the depicted embodiment, a portion of the tool shaft extends out of the casing 402.

The powered torque tool 400 may comprise the driving member 404. The driving member 404 may be connected to the tool shaft. The driving member 404 may be connected to the electrical motor by means of the tool shaft. The driving member 404 may comprise an engaging element 405. The engaging element 405 may be adapted to engage the drivable member 208 to transfer torque to the torque receiving arrangement 250 of the torsion spring tensioning tool 100. In one embodiment, the engaging element 405 may be adapted to engage the drivable member 208 to transfer torque to the torque receiving arrangement 250. In one embodiment, the engaging element 405 may be adapted to engage the engagement member of the drivable member 208. The engaging element 405 may be considered a power torque tool engaging element.

Advantageously, the gear mechanism 54 may comprise a plurality of cogged wheels 51, 52 engaging the gear wheel 21. The plurality of cogged wheels provides additional support for the gear wheel even when the gear wheel is subjected to a large torque. This is particularly advantageous due to the large torques present in the counterbalancing mechanism.

In the depicted embodiment, the gear mechanism 54 comprises a drive gear wheel 53. The drive gear wheel 53 may be fix relative the drivable member 208 such that the torque transferred to the drivable member 208 causes rotation of the drive gear wheel 53. In order to save space, the drive gear wheel 53 may be in engagement with the plurality of cogged wheels 51, 52 engaging the gear wheel 21. The drive gear wheel 53 may be coaxial with the drivable member 208.

The gear mechanism 54 may be adapted to be rotated by the powered torque tool 400. The gear mechanism 54 is thus connectable to the powered torque tool 400 by means of the torque receiving arrangement 250. The drivable member 208 is thus connectable to the powered torque tool 400.

The torque receiving arrangement depicted in FIG. 2 with the powered torque tool 400 directly engaging a drivable member 208 provided on one of the cogged wheels of the gear mechanism allows for a more compact torsion spring tensioning tool.

In an alternative embodiment, where a larger torque is prioritized, the torque receiving arrangement may be provided as a worm gear mechanism. Accordingly, the drivable member 208 may be connected to a worm gear shaft. The worm gear mechanism allows for a more cost-efficient manner of transferring torque to the gear wheel without sacrificing performance.

Further referencing FIG. 2, the plurality of cogged wheels 51, 52 may be in engagement with the gear wheel 21 for providing rotational support for said gear wheel 21 and transferring torque to the gear wheel 21. The plurality of cogged wheels 51, 52 may be rotatably coupled to the housing 80 and the gear wheel 21 to function as a reduction gearing. Accordingly, the plurality of cogged wheels 51, 52 may be considered a reduction gearing.

The plurality of cogged wheels 51, 52 may be rotatably arranged in the housing 80.

The plurality of cogged wheels 51, 52 may be distributed along the circumference of gear wheel 21. As depicted in FIG. 2, the plurality of cogged wheels may comprise a first cogged wheel 51 and a second cogged wheel 52. The first and second cogged wheel may be distributed along a first half of the circumference of the gear wheel 51.

Hence, the first cogged wheel 51 and the second cogged wheel 52 may be arranged on opposite sides of the gear wheel 21 relative a rotation axis of the gear wheel 21. The first cogged wheel 51 may thus be arranged on a first side of the rotation axis and the second cogged wheel 52 may be arranged on a second side of the rotation axis, the second side being opposite to the first. This ensures sufficient support for the gear wheel even when the tool is subjected to large torques.

The first and second cogged wheel 51, 52 may each be connected to, e.g. engage, the drivable member 208. In the depicted embodiment, the drivable member 208 is arranged between the first and second cogged wheel 51, 52. The drive gear wheel 53 may be arranged between said first and second cogged wheel 51, 52.

Each of the cogged wheels 51, 52 may be rotatably arranged in the housing 80. Each of the cogged wheels 51, 52, is connected to the housing by means of shafts arranged in the housing 80.

The gear wheel 21 comprises teeth along the circumference of said gear wheel 21. Said teeth extends radially outwards from a center of the gear wheel 21. Said teeth may extend radially outwards from a rotational axis of said gear wheel 21. In one embodiment, the gear wheel 21 may comprise a gear rim. The gear rim is arranged along the circumference of the gear wheel. The gear rim may comprise the teeth. The term gear rim herein refers to a toothed surface. The toothed surface consequently forms the engagement interface of a gear.

Preferably, the gear wheel 21 is formed as a partial ring gear wheel, i.e. a section of a full ring gear wheel. Thus, the gear wheel 21 may be a non-continuous ring gear wheel provided with an opening along the gear rim.

In one embodiment, the gear wheel 21 is formed as a partial ring wheel and the housing 80 has an open end such that the engaging arrangement 32 can be brought into engagement with the shaft, from a direction extending orthogonally to the shaft, e.g. in the same plane as the gear wheel 21. The housing 80 may have an open end such that the gear wheel 21 protrudes out of said housing 80 to accommodate for mounting of the gear wheel arrangement 20 to the shaft of the counterbalancing mechanism.

The gear wheel 21 may further include an aperture for receiving the shaft. The engaging arrangement 32 may be arranged such that the engagement interface associated with the shaft engages the engaging arrangement upon the shaft being received in said aperture. The aperture may extend in a radial direction relative the gear wheel 21. The aperture may be in the form of a recess extending through a portion of the gear wheel 21. Preferably, the aperture may comprise a rounded end portion adapted to accommodate the shaft.

Advantageously, the gear wheel 21 may be arranged such that the aperture is accessible outside of the housing 80. Thus, the aperture may be arranged outside said housing 80.

Again referencing FIG. 2, the torsion spring tensioning tool 100 may comprise one or more mounting member 97 for arranging the gear wheel 21 relative the housing 80. The one or more mounting members 97 may be adapted to be fix relative to the housing 80. The mounting member allows for a robust and space-efficient mounting of the gear wheel in the housing. Further, the one or more mounting member may reduce the noise generated by the tool during tensioning.

The one or more mounting member 97 may be adapted to rotatably mount the gear wheel 21 to the housing 80. Thus, the gear wheel 21 may be rotatably arranged in the housing 80 by means of the one or more mounting members 97. The one or more mounting members 97 may be mounted to the housing 80.

In one embodiment, the gear wheel 21 may be positioned between a first and second part of a mounting member 97. Hence, a first portion of the mounting member 97 may be arranged between the housing 80 and the gear wheel 21 on one side of the gear wheel 21. Correspondingly, a second portion of the mounting member 97 may be arranged between the housing 80 and the gear wheel 21 on the other, opposite, side of the wheel 21. Said sides may be considered axial sides. The gear wheel 21 may be arranged between first and second portion of the mounting member 97 relative an axial direction of the gear wheel 21.

In one embodiment, the torsion spring tensioning tool 100 may comprise a first mounting member and a second mounting member. The first mounting member and the second mounting member may be arranged between the housing 80 and the gear wheel 21 on opposite sides of the gear wheel 21. Thus, the first mounting member may be arranged on a first side of the gear wheel 21 and the second mounting member may be arranged on a second side of the gear wheel 21. The gear wheel 21 may be rotatably arranged between the first and second mounting member 97. The first and second side may be axial sides of the gear wheel 21. Thus, the first mounting member may be arranged on a first side of the gear wheel 21 relative an axial direction of the gear wheel 21 and the second mounting member may be arranged on a second side of the gear wheel 21 relative an axial side of the gear wheel 21.

In one embodiment, the one or more mounting members 97 is adapted to be fix relative to the housing 80 such that the gear wheel 21 is in sliding engagement with said one or more mounting member 97 and rotatable relative the mounting member 97. The sliding engagement further reduces the noise generated by the tool during tensioning.

Preferably, the gear wheel 21 may be clamped between a first mounting member and a second mounting member such that the gear wheel 21 is in sliding engagement with the first and second mounting member 97. The gear wheel 21 may be rotatably arranged between the first and second mounting member 97.

The torsion spring one or more mounting member 97 may comprise a sliding bearing adapted to be in sliding engagement with the gear wheel 21. In one embodiment, the gear wheel 21 may be positioned between a sliding bearing of a first mounting member and a sliding bearing of a second mounting member.

In one embodiment, the sliding bearing 97 may be in a low-friction material. For example, the sliding bearing 97 may be in polyamide (nylon).

The sliding bearing is adapted to hold the gear wheel 21 in position while allowing for the gear wheel 21 to rotate. Hence, the gear wheel 21 is allowed to rotate relative the housing while being held fixed in an axial direction (relative to the shaft).

In one embodiment, the sliding bearing may be provided as an outer plate mounted to a main body of the mounting member 97. It may however also be envisioned that the entire mounting member 97 is formed as a sliding bearing.

Further referencing FIG. 2, the one or more mounting member 97 may be mounted to the housing 80. The sliding bearing may be mounted to the housing 80 by means of one or more mounting member fastening elements 98.

In one embodiment, the mounting member 97 may be arranged to be in sliding engagement with the gear wheel 21.

The gear wheel 21 and the housing 80 may be adapted such that the engaging arrangement 32 can be brought into engagement with the shaft from a direction extending orthogonally to the shaft.

With the ring wheel shape, the engaging arrangement can be brought into engagement with the shaft in a direction orthogonal to the shaft allowing use of the tool even for doors arranged in tight spaces.

As aforementioned, the torsion spring tensioning tool 100 comprises a housing 80. The gear wheel 21 is rotatably arranged in the housing 80.

The gear wheel 21 may comprise a gear flange 83. The gear flange 83 comprises may comprise a first lip 84 arranged on one axial side of the gear wheel 21 to form an axially facing outer surface of the gear wheel 21. The gear flange 83 may comprise a second lip 85 arranged on the other axial side of the gear wheel 21 to form an axially facing outer surface of the gear wheel. The gear flange 83 may be curved. The gear flange 83 may extend along the outer circumference of the gear wheel 21.

The flange 83 may comprise a first and second curved lip mounted axially extending protrusion on opposite sides of the gear wheel 21.

As depicted in FIG. 2, the mounting element 97 may be in sliding engagement with the gear flange 83. A circumferentially extending surface extending in an axial direction of the gear wheel 21 of the gear flange 83 may be in sliding engagement with a circumferentially extending surface of the mounting element 97.

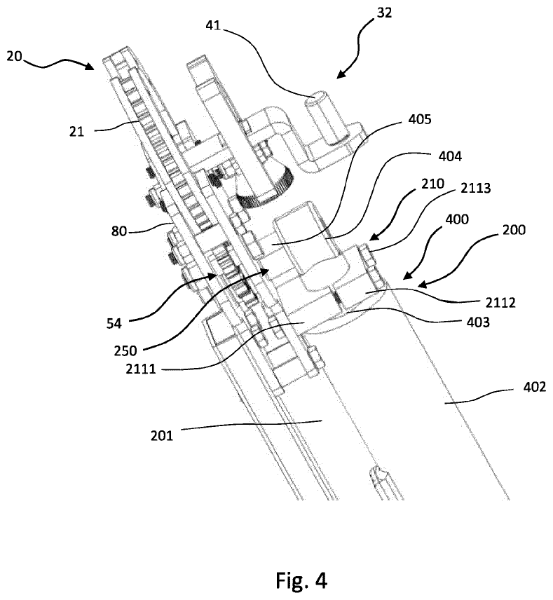

The one or more engaging members 41 of the engaging arrangement, which will be further described with reference to FIG. 4, may be arranged to face the center of said aperture. The one or more engaging members may thus be arranged to engage the engagement interface when the shaft is received in the aperture.

The gear mechanism 54 may rotate the gear wheel 21 during operation of the tensioning tool 100. Since the engaging arrangement 32 is arranged to be fixed relative to the gear wheel 21 and the engaging arrangement in operation is connected to the torsion spring of the counterbalancing mechanism and transmits a rotational movement from the gear wheel 21 to the torsion spring, the torsion spring is wound when the gear wheel 21 is rotated. Depending on the direction of the rotation of the gear wheel 21, the torsion spring is either wound up and thereby tensioned or unwound and thereby relaxed, the latter implying that the tension of the torsion spring is reduced.

The gear mechanism provides rotational support to the gear wheel, whereby a more robust tensioning tool is achieved. Further, a safer tensioning is achieved due to the tool being less susceptible to the large torque exerted to the tool by the torsion spring.

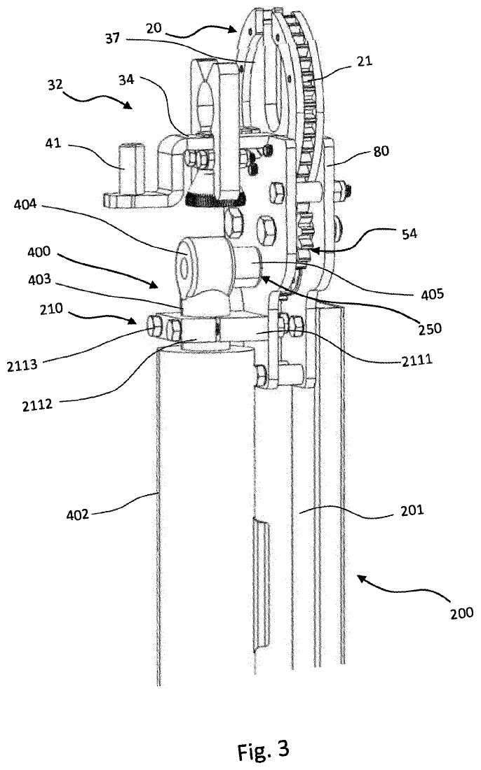

As most clearly depicted in FIG. 3, the engaging arrangement 32 may comprise one more engaging members 41. Advantageously, in order to achieve a more space-efficient tool, the engaging arrangement 32 may comprise a single engaging member 41. The one or more engaging member 41 may be adapted to engage a set of corresponding engagement members of the shaft.

The engaging arrangement 32 may be adapted to be connected to the torsion spring of the counterbalancing mechanism. This may be performed by connecting the engaging arrangement 32 to the shaft of the counterbalancing mechanism which in turn is connected to said torsion spring. The engaging arrangement 32 may be adapted to be connected to a winding cone, which is connected to the torsion spring. The winding cone may be formed as a part of the shaft of the counterbalancing mechanism.

The one or more engaging members 41 may be adapted to engage corresponding engagement members of the shaft of the counterbalancing mechanism.

The one or more engaging members 41 may be radially connectable to the torsion spring. The one or more engaging members may be radially connectable to a winding cone, which is connected to the torsion spring and forms a part of the shaft of the counterbalancing mechanism. The winding cone comprises the corresponding engagement members of the shaft of the counterbalancing mechanism.

The corresponding engagement members may be holes. Preferably, the corresponding engagement members may be radial holes.

Accordingly, the one or more engaging members 41 may be radially insertable into the corresponding engagement members (radial holes) in the winding cone. A winding cone usually comprises several radial holes, commonly four radial holes. The one or more engaging members 41 may be radially insertable in at least a plurality of the radial holes of the winding cone. In operation, the one or more engaging member 41 transmits a rotational movement from the gear wheel 21 to the torsion spring.

Preferably, the one or more engaging member 41 may be in the form of pins. In one embodiment, the one or more engaging members 41 of the engaging arrangement comprises one or more movable pins 41.

The one or more engaging member 41 may comprise an adjustable pin or a fix pin and at least one retractable pin. The adjustable pin may be a threaded adjustable pin.

The engaging arrangement 32 may comprise one or more distance members 34 adapted to arrange the gear wheel 21 remote from the torsion spring. The one or more distance member 34 are also adapted to arrange the gear wheel 21 remote from the winding cone of the torsion spring. Thereby, the gear wheel 21 is arranged remote from the torsion spring such that there is a distance between the gear wheel 21 and the torsion spring as well as the winding cone. The distance between the gear wheel 21 and the torsion spring as well as the winding cone enables mounting of a key on the shaft, which key rotationally locks the winding cone on the shaft.

The key may be insertable into a key groove formed in the shaft of the counterbalancing mechanism and a key groove formed in the winding cone. In one embodiment, the one or more engaging members 41 are each connected to a respective distance member 34 such that the one or more engaging members 41 are arranged remote from the gear wheel 21. The one or more distance members 34 extends axially from the gear wheel 21. The one or more engaging members 41 each extends radially from the respective distance member 34.

In one embodiment, the one or more engaging members 41 may extend radially from a distal end of their respective distance member, which distal end is opposite to a proximal end attached to the gear wheel. The one or more distance members 34 may be elongated distance members 34. Each distance member 34 and corresponding engagement member 41 may together have an L-shape.

The engaging arrangement 32 may comprise a fixating plate 37. Said fixating plate 37 is attached to the gear wheel 21. The one or more distance members 34 may be formed as protrusions extending axially from said fixating plate 37. A first main surface of the fixating plate 37 may be in contact with the gear wheel 21. The one or more distance members 34 may protrude axially from a second main surface of the fixating plate, said second main surface being opposite to the first main surface.

FIG. 4 depicts the torsion spring tensioning tool 100 from another view more clearly showing the torque tool mounting arrangement 200 according to an embodiment.

Referencing FIG. 4, the torque tool mounting arrangement 200 may comprise a clamping device 210. The clamping device 210 may be adapted to releasably clamp a portion 403 of the powered torque tool 400 to fixate the powered torque tool 400 to the torsion spring tensioning tool 100. The clamping device allows for easy mounting the powered torque tool to the torsion spring tensioning tool. Further, the clamping device provides a robust and stable mounting of the powered torque tool to the torsion spring tensioning tool.

In one embodiment, a portion of the tool shaft may extend through a tool shaft casing 403. In the depicted embodiment, the clamping device 210 may adapted to releasably clamp a portion of the tool shaft casing 403.

Advantageously, the clamping device 210 may comprise a first clamping element 2111 and a second clamping element 2112. The first and second clamping element 2111, 2112 may be adapted to be arranged in a clamping position to retain the portion 403 of the powered torque tool. In the clamping position, the first and second clamping element 2111, 2112 are adapted to be arranged in a clamping position to retain the portion 403 of the powered torque tool in a space formed between the first and second clamping element 2111, 2112. Thus, the first and second clamping element 2111, 2112 are adapted to engage the portion 403 of the powered torque tool 400 to retain said portion 403 of the powered torque tool 400 when the first and second clamping element 2111, 2112 are arranged in the clamping position.

The first and second clamping element 2111, 2112 may each comprise a clamping portion adapted to engage the portion 403 of the powered torque tool 400. The clamping portion of the first element 2111 and the clamping portion of the second clamping element 2112 may be arranged to face each other when the first and second clamping element 2111, 2112 are arranged in the clamping position. The clamping portions of the first and second clamping element 2111, 2112 may form the space between the first and second clamping element 2111, 2112 when the first and second clamping element 2111, 2112 are arranged in the clamping position.

The shape of the clamping portion of the first and second clamping element may be adapted to correspond to the outer shape of the portion 403 of the powered torque tool 400. Thus, depending on the type of powered torque tool 400 intended to be mounted to the torsion spring tensioning tool 100, the shape of the clamping portion of the first and second clamping element 2111, 2112 may vary. In the depicted embodiment, the portion 403 of the powered torque tool 400 intended to be clamped by the clamping device has a substantially circular cross-section. Thus, the clamping portion of the first and second clamping element 2111, 2112 may have a corresponding arc-shaped recess adapted to engage said substantially circular cross-section.

Although the depicted embodiments only includes two clamping elements, it may be envisioned that tool may comprise additional clamping elements, forming the clamping device.

In one embodiment, the first clamping element 2111 and the second clamping element 2112 may be adapted to be connected to each other in the clamping position to retain the portion 403 of the powered torque tool 400 in the space formed between the first clamping element 2111 and the second clamping element 2112 in the clamping position.

Further referencing FIG. 4, the torque tool mounting arrangement 200 may comprise a support member 201. The support member 201 is adapted to support the powered torque tool 400 when the powered torque tool is retained by the torque tool mounting arrangement 200. This allows for the powered torque tool to be sufficiently secured to the torsion spring tensioning tool and mitigates the risk for the powered torque tool to be released from the torsion spring tensioning tool during use.

The support member 201 may be connected to the housing 80. In one embodiment, the support member 201 may be mounted to said housing 80. The support member 201 may be in metal material such as steel or aluminum.

Advantageously, the support member 201 may extend from the housing 80 in a direction facing away from the gear wheel arrangement 20 and/or the engaging arrangement 32.

In one embodiment, the support member 201 may be an elongated support member. In one embodiment, the support member 201 may be formed as a handle for the torsion spring tensioning tool 100. Thus, the support member 201 may form part of a handle adapted to be held by the user of the torsion spring tensioning tool 100. The handle facilitates mounting of the torsion spring tensioning tool on the shaft of the counterbalancing mechanism and operation of the torsion spring tensioning tool since the housing can easily be moved by hand during mounting and easily be kept by hand during operation.

In one embodiment, the torque tool mounting arrangement 200 may be adapted to fixate the powered torque tool 400 against the support member 201.

In one embodiment, the clamping device 210 may be mounted to the support member 201.

As depicted in FIG. 1-4, the clamping device 210 may be adapted to in the clamping position clamp the powered torque tool 400 against the support member 201. In the clamping position, the clamping device 210 may be adapted to exert a contact force onto the powered torque tool 400 clamping said powered torque tool 400 against the support member 201.

In order to accommodate easy use of the torsion spring tensioning tool, it may be advantageous that the torsion spring tensioning tool 100 is compatible with different types of powered torque tools 400. Hence, the clamping device 210 may at least be partially interchangeable to accommodate mounting of different types of powered torque tools 400. The torsion spring tensioning device 100 thus allows for different types of powered torque tools 400 to be mounted to the torsion spring tensioning tool 100. In one embodiment, the clamping device 210 is interchangeable to accommodate mounting of different types of powered torque tools 400.

In order to allow for different types of powered torque tools 400 to be mounted to the torsion spring tensioning tool 100, adapter units may be utilized. In order to form a kit, i.e. a torsion spring tensioning tool kit, one or more adapter units may be provided. The one or more adapter units may be adapted to alter or at least partially replace the clamping device 210 to accommodate clamping of different types of powered torque tools 400.

In one embodiment, at least one of the first and second clamping element 2111, 2112 may be interchangeable. Preferably, both the first and second clamping element 2111, 2112 may be interchangeable. Thus, the first and/or second clamping element 2111, 2112 with a first type of clamping portions intended for powered torque tools of a first type may be interchangeable with other first and/or second clamping elements with a second type of clamping portions intended to retain powered torque tools of a second type. In order to increase the modularity of the torsion spring tensioning tool it is preferential that both the first and second clamping device 2111, 2112 is interchangeable. It may however be possible that one of the first and second clamping device is interchangeable while the other is fixed.

Thus, the one or more adapter units may comprise one or more interchangeable first clamping elements. Additionally or alternatively, the one or more adapter units may comprise one or more interchangeable second clamping element.

Preferably, the clamping device 210 may be detachably mounted to the elongated support member 201. In the depicted embodiment, the first clamping element 2111 is mounted to the elongated support member 201. The second clamping element 2112 is detachably mounted to the first clamping element 2111. The second clamping element 2112 is detachably mounted to the first clamping element 2111 by means of one or more clamping device fastening members 2113. The clamping device fastening members 2113 may be in the form of screws or any other type of conventional and suitable fastening members available for the skilled person.

FIG. 5 depicts a torsion spring tensioning tool 100 according to another embodiment. In the depicted embodiment, the torsion spring tensioning tool 100 comprises a torque receiving arrangement 250 of a different design.

Referencing FIG. 5, and in accordance with the embodiment depicted in FIGS. 1-4, the torque receiving arrangement 250 comprises the drivable member 208. The drivable member 208 is adapted to be brought into engagement with the driving member of the powered torque tool for transfer of torque to the gear wheel 21. Contrary to the embodiment depicted in FIGS. 1-4, this embodiment does not include a torque tool mounting arrangement adapted to releasably retain the powered torque tool.

Similar to the embodiment depicted in FIGS. 1-4, the drivable member 208 is adapted to transfer the torque provided by the driving member of the powered torque tool to the gear mechanism 54 via the drivable member 208.

The drivable member 208 may be arranged in a bearing provided in the housing 80.

Further referencing FIG. 5, the torsion spring tensioning tool may further comprise a handle 75. The handle facilitates mounting of the torsion spring tensioning tool on the shaft of the counterbalancing mechanism and operation of the torsion spring tensioning tool since the housing can easily be moved by hand during mounting and easily be kept in position by hand during operation. The handle 75 is coupled to the housing 80. The handle 75 comprises an elongated handle element 76.

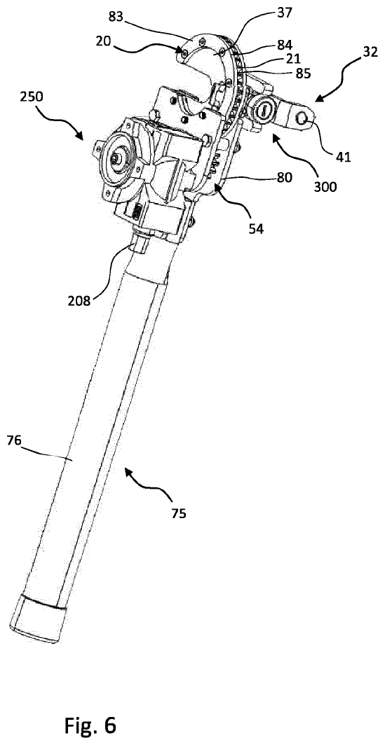

Turning to FIG. 6, another embodiment of the torsion spring tensioning tool 100 is depicted. The torque receiving arrangement 250 is in the depicted embodiment provided as a worm gear mechanism. The drivable member 208 may be connected to a worm gear shaft of the worm gear mechanism. The worm gear mechanism allows for a cheaper and more compact manner of transferring torque to the gear wheel without sacrificing performance.

The worm gear shaft may in turn be connected to the gear mechanism 54 for transferring the torque provided by the driving member of the powered torque tool to the gear mechanism 54. In one embodiment, the worm gear mechanism may further comprise a reduction gearing. Thus, the drivable member 208 may be connected to the gear mechanism 54 via the reduction gearing.

Compared to the embodiment of FIG. 5, the embodiment of FIG. 6 may be particularly suitable for connecting to a powered torque tool without an internal gearbox such as a drilling machine or a driven screwdriver in the form of for example an in-line screw driver since the reduction gearing may be provided by the torsion spring tensioning tool instead. The embodiment of FIG. 5 requires less space but may be more reliant on the powered torque tool in itself providing a controlled torque and comprising a reduction gearing in the form of for example a gearbox.

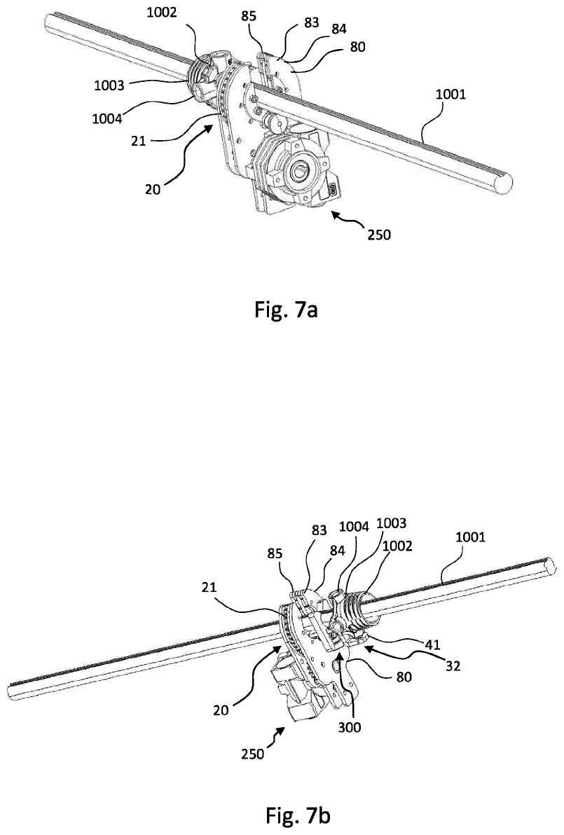

FIG. 7a-7b depicts a torsion spring tensioning tool 100 according to one embodiment. The depicted embodiment includes a mounting member according to one example.

Referencing 7a-b, the torsion spring tensioning tool 100 is mounted to the shaft of the counterbalancing mechanism. Thus, the engaging arrangement 32 may be connected to the torsion spring of the counterbalancing mechanism. This is performed by the engaging arrangement 32 being connected to the shaft 1001 of the counterbalancing mechanism which in turn is connected to said torsion spring. The engaging arrangement 32 may be connected to the winding cone 1002, which may be connected to the torsion spring. The winding cone 1002 may be formed as a part of the shaft 1001 of the counterbalancing mechanism.

The one or more engaging members 41 may engage corresponding engagement members of the shaft 1001 of the counterbalancing mechanism.

The one or more engaging members 41 may be radially connected to the torsion spring. The one or more engaging members 41 may be radially connected to the winding cone 1002. The winding cone 1002 is connected to the torsion spring and forms a part of the shaft 1001 of the counterbalancing mechanism. The one or more engaging members 41 may be in engagement with at least one of the corresponding engagement members 1004. The winding cone 1002 may comprise the corresponding engagement members 1004 of the shaft 1001 of the counterbalancing mechanism. The corresponding engagement members 1004 may be holes. Preferably, the corresponding engagement members 1004 may be radial holes.

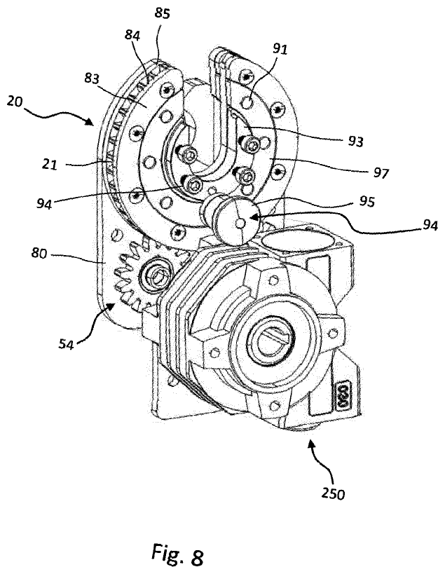

The torsion spring tensioning tool 100 is depicted in further detail in FIG. 8. As described with reference to FIG. 1-4, the mounting member 97 may be adapted to be fix relative the housing 80. In one embodiment, the mounting member 97 may be arranged to be in sliding engagement with the gear wheel 21 and preferably with a gear flange 83 of the gear wheel 21.

At least one of the one or more mounting members 97 may be releasably mounted to the housing 80. The mounting member 97 may be mountable to the housing 80 in an unblocking position and a blocking position. In the unblocking position, the mounting member 97 may be arranged such that the engaging arrangement 32 can be brought into engagement with the shaft. In the blocking position, the mounting member 97 may be arranged such that the mounting member 97 blocks relative movement between the torsion spring tensioning tool and the shaft in a direction extending substantially orthogonal to the shaft.

By utilizing the mounting member to block and unblock relative movement between the shaft and the torsion spring tensioning tool, the risk for the torsion spring tensioning tool accidentally disengaging the shaft during tensioning is reduced. Furthermore, by utilizing the mounting member for this function, a more space-efficient torsion spring tensioning tool is achieved.

Referencing FIG. 8, the torsion spring tensioning tool 100 may comprise a first and second mounting member 97. The first mounting member may be mountable in the blocking and unblocking position and the second mounting member may be intended to be stationary, i.e. only mounted at a set position relative the housing 80.

The gear wheel 21 may be, as previously described with reference to FIGS. 1-4, formed as a partial ring wheel. The housing 80 may have an open end such that the engaging arrangement 32 can be brought into engagement with the shaft from a direction extending orthogonally to the shaft.

Accordingly, in the unblocking position, the mounting member 97 may be arranged such that the engaging arrangement 32 can be brought into engagement with the shaft. Further, in the blocking position, the mounting member 97 may be arranged to block passage of the shaft through the open end.

Thus, in the blocking position, the mounting member 97 may extend across the aperture of the gear wheel 21 thereby blocking relative movement between the shaft and the torsion spring tensioning tool 100 along the aperture of the gear wheel 21. Hence, in the blocking position, the mounting member 97 and the gear wheel 21 may together form an annular rim, e.g. a full ring gear.

Correspondingly, in the unblocking position, the mounting member 97 may be positioned relative the gear wheel 21 such that the aperture is accessible for engaging and disengaging the shaft by means of relative movement between the shaft and the torsion spring tensioning tool 100 along the aperture of the gear wheel 21. Hence, in the unblocking position, the mounting member 97 and the gear wheel 21 may together form a partial rim, e.g. a partial ring gear.

In one embodiment, the torsion spring tensioning tool 100 may further comprise a releasable mounting 94. The releasable mounting 94 may be adapted to releasably fix the mounting member 97 to the housing 80 in the blocking and/or unblocking position. The releasable mounting allow for easy mounting of the mounting member in the blocking position and the unblocking position.

Preferably, the releasable mounting 94 is adapted to releasably fix the mounting to the housing 80 by means of being connected to connection means provided in the housing 80. The connection means may be in form of for example recesses, holes or grooves provided in the housing 80. Said connection means are adapted to be engaged by the releasable mounting 94.

Referencing FIG. 8, the releasable mounting 94 may comprise one or more releasable mounting element 95. The one or more releasable mounting element 95 may be adapted to engage the mounting member 97 and the housing 80 to fix the mounting 97 in the blocking position and/or the unblocking position. The mounting member 97 may comprise mounting means 91. The one or more releasable mounting element 95 may be adapted to releasably engage the mounting means 91 to fix the mounting member 97 in the blocking and/or unblocking position.

The releasable mounting element 95 may extend through the connection means provided in the housing 80, thereby allowing said releasable mounting element 95 to releasably fix the mounting element 97 to the housing 80.

In one embodiment, the releasable mounting element 95 may extend in a axial direction relative the mounting member 97. Thus, the releasable mounting element 95 may extend in an axial direction relative the gear wheel 21. The releasable mounting element 95 may be adapted to releasably and axially engage the mounting means 91.

In the depicted embodiment, the releasable mounting 94 comprises a releasable mounting element 95 adapted to releasably engage the mounting means 91 to fix the mounting member 97 in the blocking position. Furthermore, the releasable mounting element 95 may be adapted to releasably engage the mounting means 91 to fix the mounting member 97 in the unblocking position.

In one embodiment, the mounting means 91 may comprise one or more holes provided in the mounting member 97. In one embodiment, the mounting means 91 may comprise a plurality of holes distributed along the mounting member 97. In one embodiment, the plurality of holes may be distributed along a circumferential direction of the mounting member 97. In one embodiment, the one or more holes may be axially extending. The one or more releasable mounting element 95 may thus be adapted to axially engage the one or more axially extending holes.

In one embodiment, the releasable mounting element 95 may be a spring-loaded pin. The spring-loaded pin may be biased towards the mounting member 97. The spring-loaded pin may be adapted to releasably engage the mounting means 91. The spring-loaded pin may be operable with one hand, making it easy for the mounting member to be moved by hand of the user.

Again referencing FIG. 8, the mounting member 97 may be rotatable between the blocking position and the unblocking position. Thus, the s mounting member 97 may be arranged to be rotatable relative the housing 80 upon the release of the releasable mounting 94, e.g. when the one or more releasable mounting element is out of engagement with the mounting means 91. Accordingly, the mounting member 97 may be rotatably arranged in the housing 80 and fixable to the housing in the blocking and unblocking position.

The mounting member 97 may be rotatably arranged in a seat formed in the housing 80. The seat may be formed by the gear flange 83 and/or the inner rim of the gear wheel 21 and the housing 80.

In one embodiment, the torsion spring tensioning tool 100 may further comprise a bearing support member 93. The bearing support member 93 may form a part of the housing 80. In one embodiment, the seat may be formed by the bearing support member 93 and the gear flange 83 and/or the inner rim of the gear wheel 21. Hence, an outer circumferentially extending surface of the mounting member 97 may be in sliding contact with the gear flange 83 and/or the inner rim of the gear wheel 21. An inner circumferentially extending surface of the mounting member 97 may be in sliding contact with the bearing support member 93.

As described with reference to FIG. 2, an inner circumferential axially extending surface of the gear wheel 21 formed by the gear flange 83 may be in sliding engagement with an outer circumferential axially extending surface of the mounting member 97.

The mounting member 97 may be substantially annular. The mounting member 97 may be formed as a partial annular element. Thus, the mounting member 97 may comprise a radially extending opening. The radially extending opening may be adapted to radially receive the shaft of the counterbalancing mechanism. The radially extending opening may be arranged to be aligned with the aperture of the gear wheel 21.

Preferably, the mounting member 97 may be arranged to be coaxial to the gear wheel 21.

Although depicted with a worm gear mechanism, the design and further details concerning the mounting member may be freely implemented to the embodiments depicted in FIGS. 1-4 as well as the embodiment depicted in FIG. 5.

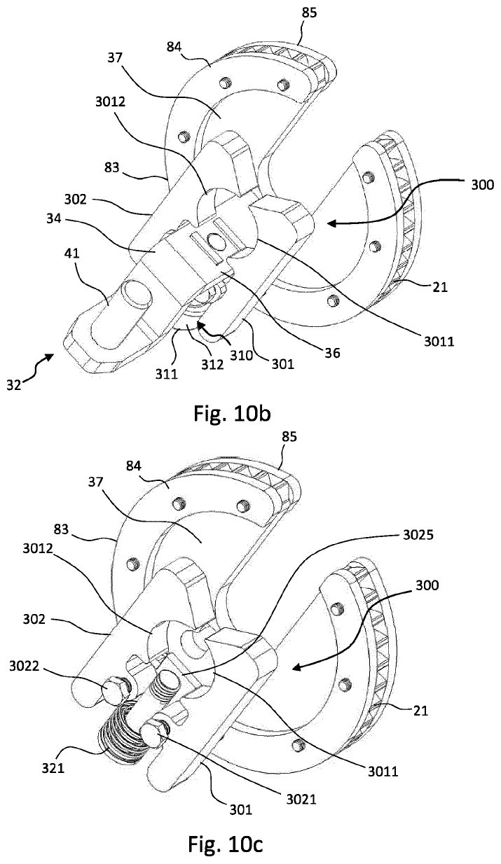

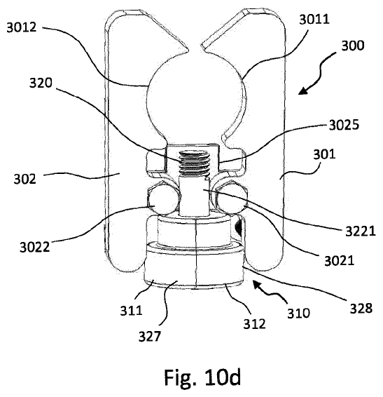

FIG. 9a-e depicts a gripping arrangement of the torsion spring tensioning tool according to an embodiment. FIG. 10a-d depicts a gripping arrangement according to another embodiment. The gripping arrangement depicted in FIG. 10a-d is identical to the gripping arrangement depicted in FIG. 9a-e with the exception of the design of the actuatable mechanism 311 of the gripping arrangement 300.

As depicted, the torsion spring tensioning tool 100 may comprise a gripping arrangement 300. The gripping arrangement 300 may be adapted to releasably engage the shaft of the counterbalancing mechanism by means of gripping said shaft of the counterbalancing mechanism. The gripping arrangement 300 reduces the risk for the torsion spring tensioning tool 100 losing its engagement with the shaft during tensioning. Thereby, a more safe torsion spring tensioning tool is achieved.

Advantageously, the gripping arrangement 300 is adapted to engage the shaft such that movement of the tool orthogonally to the shaft is prohibited when the gripping arrangement grips said shaft. A benefit with such a gripping arrangement is that the torsion spring tensioning tool is more robust and stable during tensioning.

Preferably, the gripping arrangement 300 may be adapted to come into contact with the shaft upon engaging the shaft. The gripping arrangement being arranged into contact with the shaft reduces the risk for the torsion spring tensioning tool wriggling during tensioning.

In one embodiment, the gripping arrangement 300 may be connected to the gear wheel 21. The gripping arrangement 300 may be mounted to the fixating plate 37. In one embodiment, the gripping arrangement 300 may be mounted to the engaging arrangement 32. Thus, the gripping arrangement 300 may be connected to the gear wheel 21 by means of the engaging arrangement 32. As depicted in FIG. 5-6, the gripping arrangement 300 may be mounted to a distance member 34 of the engaging arrangement.

It may however be envisioned that the gripping arrangement 300 is mounted directly to the gear wheel 21 or fixating plate 37 or mounted directly to the housing 80 of torsion spring tensioning tool 100.

In one embodiment, the gripping arrangement 300 may be axially displaced relative the gear wheel 21. In one embodiment, the gear wheel 21 may be arranged coaxially with the gripping arrangement 300.

Further referencing FIGS. 9 and 10, the gripping arrangement 300 may comprise a first gripping member 301. The gripping arrangement 300 may comprise a second gripping member 302. The first gripping member 301 may be adapted to grip at least partially around the shaft of the counterbalancing mechanism. The second gripping member 302 may be adapted to grip at least partially around the shaft of the counterbalancing mechanism. At least one of the first gripping member 301 and the second gripping member 302 may be movable to enable relative movement between the first gripping member 301 and the second gripping member 302 and accommodate for receiving the shaft of the counterbalancing mechanism. Thus, at least one of the first gripping member 301 and the second gripping member 302 may be movably mounted.

At least one of the first and second gripping member 301, 302 may be a pivotably mounted gripping member. Said at least one of the first and second gripping member 301, 302 being a pivotably mounted gripping member coupled to a bearing connection of the torsion spring tensioning tool 100.

Advantageously, the first and/or second gripping member 301, 302 may be arranged to be in contact with the shaft upon gripping at least partially around said shaft.

The first and second gripping member 301, 302 may each comprise an engaging portion 3011, 3012. The engaging portion 3011, 3012 of the first and second gripping member 301, 302 is adapted to engage the shaft of the counterbalancing mechanism.

The engaging portion 3011, 3012 of the first and second gripping member 301, 302 may be adapted to engage the shaft of the counterbalancing mechanism. The engaging portion 3011 of the first gripping member 301 and the engaging portion 3012 of the second gripping member 302 may be arranged to face each other when gripping the shaft of the counterbalancing mechanism. The engaging portion 3011 of the first gripping member 301 and the engaging portion 3012 of the second gripping member 302 may form the space there between for receiving the shaft of the counterbalancing mechanism.

The shape of the engaging portion 3011 of the first gripping member 301 and the engaging portion 3012 of the second gripping member 302 may be adapted to correspond to the outer shape of the shaft of the counterbalancing mechanism. Thus, the engaging portion 3011, 3012 of the first and second gripping member 301, 302 may have comprise an arc shaped outer surface adapted to engage the shaft of the counterbalancing mechanism.

In order to secure the gripping arrangement's engagement with the shaft of the counterbalancing mechanism, a retaining mechanism 310 may be utilized. Such a retaining mechanism may be adapted to retain the gripping arrangement in a position in which it grips the shaft.

Accordingly, the gripping arrangement 300 may comprise a retaining mechanism 300. The retaining mechanism 310 may be adapted to releasably engage at least one movable gripping member of the first and second gripping member to block said at least one movable gripping member to prevent separation between the engaging portions of the first and second gripping member 301, 302.

In the depicted embodiments of FIG. 5-6, both the first and second gripping member 301, 302 are movable and the retaining mechanism is adapted to releasably engage and block the first and second gripping member 301, 302. It may however be envisioned that only one of the gripping members is movable, whereby the retaining mechanism 310 may be adapted to releasably engage and block only one movable gripping member.

The retaining mechanism 310 may comprise an actuatable mechanism 311. The actuatable mechanism 311 is adapted to be movable between a first position and a second position. In the first position, the actuatable mechanism 311 causes the retaining mechanism 310 to be out of engagement with, i.e. disengaged from, at least one movable gripping member. In the second position, the actuatable mechanism 311 causes the retaining mechanism 310 to be in engagement with the at least one movable mounted gripping member thereby blocking the at least one movable mounted gripping member. In the second position, the retaining mechanism is caused to block the at least one movable blocking member to prevent separation between the engaging portions 3011, 3012 of the first and second gripping member 301, 302.

The engaging portion 3011 of the first gripping member 301 may herein be considered a first gripping member engaging portion 3011. The engaging portion 3012 of the second gripping member 302 may herein be considered a second gripping member engaging portion 3012.

The actuatable mechanism 311 may comprise a blocking member 327. The blocking member 327 is adapted to block the movement of the at least one movable gripping member.

In one embodiment, the movable gripping member may comprise a first, second and intermediate portion. The intermediate portion is arranged between the first and second portion. The first portion may comprise the engaging portion 3011, 3012. The intermediate portion may be movably mounted. In one embodiment, the intermediate portion is pivotally mounted by means of a pivot connection 3021, 3022. The blocking member 327 may be arranged to selectively engage the second portion of the movable gripping member to block the movement of said movable gripping member to prevent separation between the engaging portions of the first and second gripping member 301, 302. Thus, upon movement of the retaining mechanism 310 from the first to the second position, the blocking member 327 may move from a position in which it is disengaged from at least one movable gripping member to a position in which engages the at least one movable gripping member. Upon movement of the retaining mechanism 310 from the second to the first position, the blocking member 327 may move from a position in which it engages at least one movable gripping member to a position in which it is disengaged from the at least one movable gripping member.

In the depicted embodiments, both the first and second gripping member 301, 302 are movable. In the depicted embodiments, a single blocking member 327 is utilized for blocking the movement of both the first and second gripping member 301, 302 to prevent separation between the engaging portion 3011 of the first gripping member 301 and the engaging portion 3012 of the second gripping member 302. When the retaining mechanism 311 is in the first position, the blocking member 327 is out of engagement with the first and second gripping member 301, 302. When the retaining mechanism 311 is in the second position, the blocking member 327 is in engagement with the first and second gripping member 301, 302. When the retaining mechanism 311 is in the second position, the blocking member 327 may be arranged between the first and second gripping member 301, 302. Preferably, when the retaining mechanism 311 is in the second position, the blocking member 327 may be arranged to be in contact with the second portion of the first and second gripping member 301, 302. Such an arrangement with two movable gripping members in combination with a single blocking element may be considered to be particularly advantageous since the retaining mechanism may be operable by one hand of the user.

Referencing FIG. 9a-e, the actuatable mechanism 311 may be adjustably movable between the first and second position.

The actuatable mechanism 311 may be adjustably connected to a portion of the torsion spring tensioning tool 100 such that the actuatable mechanism 311 is adjustable between the first and second position.

In one embodiment, the actuatable mechanism may be adjustably connected to one of the one or more distance members 34.

As depicted in FIG. 9a-e, the actuatable mechanism 311 may comprise a threaded screw 329 adjustably connected to the portion of the torsion spring tensioning tool 100. In one embodiment, the distance member 34 may comprise a threaded hole adapted to receive said threaded screw 329.

Upon rotation of the threaded screw 329, the position of the threaded screw 329 is adjusted thereby causing movement of the actuatable mechanism 311 between the first and second position.

In one embodiment, the blocking member 327 may be fix relative the threaded screw 239 such that the rotation of the threaded screw causes movement of the blocking member 327.

In one embodiment, the blocking member 327 may be tapered. The blocking member 327 may be tapered in a direction extending along the first and second gripping member 301, 302 from the second portion of said gripping members towards the first portion of said gripping members. The blocking member 327 may be substantially conical. The conical shape allows for easier separation between the gripping members due to the slanted surface making it easier to slide the blocking member out of engagement with the gripping members.

Referencing FIG. 10a-d, the retaining mechanism 310 may comprise a biasing arrangement 321. The biasing arrangement 321 may be connected to the actuatable mechanism. The biasing arrangement 321 may be adapted to bias the actuatable mechanism 311 towards the second position from the first position.

The biasing arrangement 321 allows for easy actuation of the actuatable mechanism since the biasing arrangement may be arranged such that the gripping members 301, 302 may be separable if subjected to a large enough force, i.e. a force large enough to overcome the biasing force provided by the biasing arrangement 321 blocking the separation of the gripping members 301, 302. This allows for the user to press the gripping members 301, 302 against the shaft, causing the first and second gripping member 301, 302 to separate and enable the shaft to be received between the engaging portions 3011, 3012 of the first and second gripping member 301, 302. This further causes the retaining mechanism 311 to move from the second position to the first position, i.e. moving the retaining mechanism 311 out of engagement with the one or more movable gripping member, e.g. the first and second gripping member, When the shaft is gripped by the first and second gripping member 3011, 3012, the biasing arrangement is adapted to cause the retaining mechanism to return to the second position, thereby blocking separation of the first and second gripping member 3011, 3012.

In order to disengage the tool, the actuatable mechanism 311 may be moved manually by user from the second position to the first position. Thereby, it is possible to cause sufficient separation between the gripping members in order to disengage the gripping arrangement from the shaft.

The biasing arrangement 321 may be connected to a portion of the torsion spring tensioning tool 100. The biasing arrangement 321 may connect the actuatable mechanism 311 with said portion of the tensioning tool. In one embodiment, the biasing arrangement 321 may be connected to the distance member 34. Thus, the biasing arrangement 321 may connect the distance member 34 and the actuatable mechanism 311.

In one embodiment, the biasing arrangement 321 may be connected to the blocking member 327. Thus, the biasing arrangement 321 may connect the blocking member 327 and the aforementioned portion of the torsion spring tensioning tool 100.

In one embodiment, the distance member 34 may comprise a guiding hole for movably receiving a guided member 3221 of the actuatable mechanism 311. The guiding hole is arranged to guide the movement of the actuatable mechanism 311 between the first and second position. The blocking member 327 may be fixed to the guided member 3221. Movement of the blocking member 327 may cause movement of the retaining mechanism 310 between the first and second position.

The biasing arrangement 321 may comprise a spring. The spring may be connected to the actuatable mechanism 311. The spring may be connected to the aforementioned portion of the torsion spring tensioning tool 100.

Further referencing FIG. 10a-d, the blocking mechanism 327 may comprise a retention flange 312. The retention flange may be formed as a circumferential flange of the blocking mechanism 327. The retention flange 312 may have a substantially cylindrical shape. The retention flange 312 increases the area of contact between the movable gripping member and the blocking mechanism 327 which reduces the risk for the blocking mechanism 327 to accidently disengage from the movable gripping member during use.

The retention flange may have an outer surface extending substantially parallel to the first and second gripping member 301, 302. The outer surface may thus extend in a radial direction relative to the gear wheel 21.

Although the biasing arrangement is only depicted with a blocking member with a retention flange and the threaded screw is only depicted with a conical blocking member, it is recognized that any type of plausible blocking member is combinable with any type of suitable adjustable connection for achieving the movement of the actuatable mechanism between the first and second position.

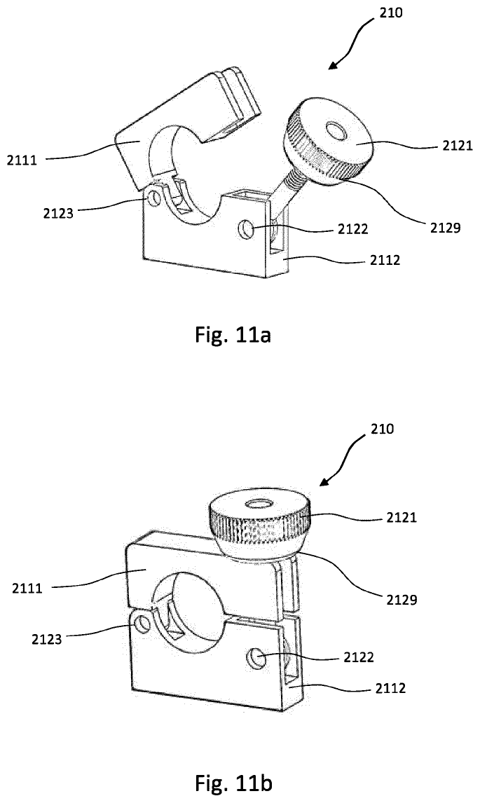

FIG. 11a-b depicts a clamping device 210 of the torque tool mounting arrangement 200 according to one embodiment. The clamping device 210 comprises the first clamping element 2111 and the second clamping element 2112. The clamping device 210 may further comprise a retaining element 2121. The retaining element 2121 may be movable between a retaining position and a disengaged position. In the retaining position, the retaining element 2121 is arranged to engage the first clamping element 2111 and/or the second clamping element 2112 in the clamping position. In the disengaged position, the retaining element 2121 allows for relative movement between the first clamping element 2111 and the second clamping element 2112.

The retaining element 2121 may be pivotable between the disengaged position and the retaining position. In one embodiment, the retaining element 2121 may be movably connected to one of the first and second clamping element. In one embodiment, the retaining element 2121 may be pivotally connected to one of the first and second clamping element. The clamping device 210 may thus comprise a pivot connection 2122 pivotally connecting the retaining element 2121 and one the first and second clamping element.

In one embodiment, the first clamping element 2111 and the second clamping element 2112 may be connected via a clamping device connection 2123. Preferably, the first clamping element 2111 and the second clamping element 2112 may be movably connected by means of said clamping device connection 2123. In one embodiment, the clamping device connection 2123 may be a hinge connection.

The retaining element 2121 may be adapted to engage a track provided in the first clamping element 2111 or second clamping element 2112 in the retaining position. In one embodiment, the retaining element 2121 may comprise a locking protrusion 2129 engaging the other of the first and second clamping element. Preferably, the locking protrusion is adapted to abut to the outer walls of the track provided in the first or second clamping element when the retaining element 2121 is in the retaining position, thereby locking the first and second clamping element 2111, 2112 in the clamping position.

A counterbalancing mechanism is usually used in overhead sectional doors. Thus, the overhead door may be an overhead sectional door.

The mounting, operation and removal of the torsion spring tensioning tool 100 according to one embodiment is hereinafter described.

The tensioning tool 100 may be mounted on a shaft of a counterbalancing mechanism and connected to a torsion spring in the following way.

The engaging arrangement 32 is brought into engagement with the corresponding engagement interface of the shaft of the overhead door, thereby engaging the winding cone of the counterbalancing mechanism. This may be performed by means of passing said engaging arrangement into engagement with said corresponding engagement interface via the open end of the housing 80. The engaging arrangement 32 is brought into engagement by a radial motion relative the shaft of the overhead door.

The torsion spring tensioning tool 100 may be operated to tension the torsion spring of the counterbalancing mechanism in the following way. A powered torque tool 400 is connected to the torque receiving arrangement 250, e.g. the drivable member 208 of the torque receiving arrangement 250 such that rotation of the driving member 404 of the powered torque tool 400 rotates the drivable member 208. The gripping arrangement 300 may be operated to engage the shaft of the counterbalancing mechanism, thereby gripping the shaft. This may be performed by means of operating the actuatable mechanism 311 to enable separation between the first and second gripping member 301, 302.

The rotation of the drivable member 208 causes rotation of the plurality of cogged wheels 51, 52 of the gear mechanism 54 in turn rotating the gear wheel 21. The plurality of cogged wheels 51, 52 may rotate the gear wheel 21 at an even lower rotational speed and the transferred torque is even higher. The rotation of the gear wheel 21 is transferred to the winding cone via the engaging arrangement 32 fix relative to the gear wheel 21. Thereby, the torsion spring is wound. To tension the torsion spring, the direction of rotation of the driving member 404 of the powered torque tool is chosen such that the torsion spring is wound up. It is easily realized that the tensioning tool can be used to relax the tension of the torsion spring by operating the driving member 404 of the powered torque tool 400 in the opposite direction.

When suitable tension of the torsion spring has been achieved, the winding cone is rotationally locked to the shaft of the counterbalancing mechanism by tightening of tightening screws arranged in the winding cone and engaging the shaft and/or by inserting a key in a key groove formed in the shaft and the winding cone.

The tensioning tool 100 can be removed from the counterbalancing mechanism in different by disengaging the engaging arrangement 32 from the shaft and operating the gripping arrangement 300 to disengage from the shaft. The gripping arrangement 300 may be disengaged from the shaft by means of operating the actuatable mechanism 311.

According to one aspect, a torsion spring tensioning tool kit is provided. The torsion spring tool kit comprises a torsion spring tensioning tool according to any of the embodiments described herein comprising an at least partially interchangeable clamping device. The torsion spring tensioning tool kit may comprise one or more adapter units. The one or more adapter units may be adapted to alter or at least partially replace the clamping device 210 to accommodate clamping of different types of powered torque tools. Worded differently, the one or more adapter units may be configured to adapt the clamping device 210 to accommodate clamping of different types of powered torque tools.

In one embodiment, the torsion spring tensioning tool kit may comprise one or more interchangeable first clamping element 2111 and/or one or more interchangeable second clamping elements 2112.

The clamping device 210 may comprise the first clamping element 2111 and the second clamping element 2112. The first and second clamping element 2111, 2112 may be adapted to be arranged in the clamping position to retain the portion 403 of the powered torque tool 400 in the space formed between the first and second clamping element 2111, 2112 in the clamping position. The one or more adapter units may comprise one or more interchangeable first and/or one or more interchangeable second clamping elements 2111, 2112.

In one embodiment, the one or more adapter unit may comprise parts of a clamping device such as a detachable gripping portion to be mounted to a clamping element or a part of a clamping element.

According to one aspect, a torsion spring tensioning tool system is provided. The torsion spring tensioning system comprises a torsion spring tensioning tool 100 according to any embodiment described herein. The torsion spring tensioning tool system may further comprise a powered torque tool 400. The powered torque tool 400 may be a powered torque tool 400 according to any one of the embodiments described herein or any other type of suitable powered torque tool 400.

According to one aspect, a torsion spring tensioning tool for tensioning a torsion spring of a counterbalancing mechanism of an overhead door is provided. The torsion spring tensioning tool 100 comprises a housing 80 and a gear wheel arrangement 20 adapted to be mounted on a shaft 1001 of the counterbalancing mechanism. The gear wheel arrangement comprises a gear wheel 21 rotatably arranged in the housing 80. The torsion spring tensioning tool 100 further comprises a gear mechanism 54 coupled to the gear wheel 21 for rotating said gear wheel 21. The gear wheel arrangement 20 comprises an engaging arrangement 32 arranged to be fixed relative to the gear wheel 21. The engaging arrangement 32 is adapted to engage the shaft 1001 of the counterbalancing mechanism and transmit a rotational movement from the gear wheel 21 to the torsion spring.

The torsion spring tensioning 100 may comprise at least one of the torque tool mounting arrangement, the one or more mounting member and the gripping arrangement according to any one of the embodiments described herein.

It should be appreciated that even though numerous characteristics and advantages of the present invention have been set forth in the foregoing description, together with details of the structure and function of the invention, the description is only illustrative and changes may be made in detail, especially in matters of shape, size and arrangement of parts within the scope of the invention to the full extent indicated by the appended claims.

1. Torsion spring tensioning tool (100) for tensioning a torsion spring of a counterbalancing mechanism of an overhead door, wherein the torsion spring tensioning tool (100) comprises a housing (80) and a gear wheel arrangement (20) adapted to be mounted on a shaft (1001) of the counterbalancing mechanism, said gear wheel arrangement (20) comprising a gear wheel (21) rotatably arranged in the housing (80), the torsion spring tensioning tool (100) further comprising a gear mechanism (54) coupled to the gear wheel (21) for rotating said gear wheel (21),
wherein the gear wheel arrangement (20) comprises an engaging arrangement (32) arranged to be fixed relative to the gear wheel (21 ), and
wherein the engaging arrangement (32) is adapted to engage the shaft (1001) of the counterbalancing mechanism and transmit a rotational movement from the gear wheel (21) to the torsion spring,
the torsion spring tensioning tool (100) further comprising a gripping arrangement (300) adapted to releasably engage the shaft (1001) of the counterbalancing mechanism by means of gripping said shaft (1001) of the counterbalancing mechanism.

2. The torsion spring tensioning tool (100) according to claim 1, wherein the gear mechanism (54) comprises a plurality of cogged wheels (51, 52) engaging the gear wheel (21).

3. The torsion spring tensioning tool (100) according to claim 2, wherein the plurality of cogged wheels (51, 52) are distributed along the circumference of the gear wheel (21).

4. The torsion spring tensioning tool (100) according to claim 1, wherein the gear wheel (21) is formed as a partial ring wheel and the housing (80) has an open end such that the engaging arrangement (32) can be brought into engagement with the shaft (1001) from a direction extending orthogonally to the shaft (1001).

5. The torsion spring tensioning tool (100) according to claim 1, wherein the engaging arrangement (32) comprises at least one engaging member (41) adapted to engage at least one corresponding engagement member (1004) of the shaft (1001) of the counterbalancing mechanism.

6. The torsion spring tensioning tool (100) according to claim 1, whereby the gear mechanism (54) comprises a torque receiving arrangement (250), the torque receiving arrangement (250) comprising a drivable member (208) adapted to be brought into engagement with a driving member (404) of a powered torque tool (400) for transfer of torque to the gear wheel (21), the torsion spring tensioning tool (100) further comprising a torque tool mounting arrangement (200) adapted to releasably retain the powered torque tool (400).

7. The torsion spring tensioning tool (100) according to claim 6, wherein the torque tool mounting arrangement (200) comprises a clamping device (210) adapted to releasably clamp a portion (403) of the powered torque tool (400) to fixate said powered torque tool (400) to the torsion spring tensioning tool (100).

8. The torsion spring tensioning tool (100) according to claim 7, wherein the clamping device (210) comprises a first clamping element (2111) and a second clamping element (2112), whereby the first and second clamping element (2111, 2112)are adapted to be arranged in a clamping position to retain the portion (403) of the powered torque tool (400) in a space formed between said first and second clamping element (2111, 2112) in said clamping position.

9. The torsion spring tensioning tool (100) according to claim 8, wherein the clamping device (210) further comprises a retaining element (2121) movable between a retaining position and a disengaged position, whereby the retaining element (2121) in the retaining position is arranged to engage the first and/or second clamping element (2111, 2112) to retain the first and second clamping element (2111, 2112) in the clamping position and in the disengaged position allow for relative movement between the first and second clamping element (2111, 2112).

10. The torsion spring tensioning tool (100) according to claim 1, wherein the engaging arrangement (32) is fix relative to the gear wheel (21) by means of being mounted to said gearwheel (21).

11. The torsion spring tensioning tool (100) according to claim 1, wherein the gripping arrangement (300) comprises a first and second gripping member (301, 302) adapted to grip at least partially around the shaft (1001) of the counterbalancing mechanism, whereby at least one of the first and second gripping member (301, 302) is movable to enable relative movement between the first gripping member (301) and the second gripping member (302) and accommodate for receiving the shaft (1001) of the counterbalancing mechanism.

12. The torsion spring tensioning tool (100) according to claim 11, wherein the first and second gripping member (301, 302) each comprises an engaging portion (3011, 3012) adapted to engage the shaft (1001) of the counterbalancing mechanism.

13. The torsion spring tensioning tool (100) according to claim 12, wherein the gripping arrangement (300) further comprises a retaining mechanism (310) adapted to releasably engage at least one movable gripping member of the first and second gripping member (301, 302) to block said at least one movable gripping member to prevent separation between the engaging portions (3011, 3012) of the first and second gripping member (301, 302).

14. The torsion spring tensioning tool (100) according to claim 13, wherein the retaining mechanism (310) comprises an actuatable mechanism (311) adapted to be movable between a first position wherein the actuatable mechanism (311) causes the retaining mechanism (310) to be out of engagement with at least one movable gripping member thereby allowing for movement of the at least one movable gripping member and a second position wherein the actuatable mechanism (311) causes the retaining mechanism (310) to be in engagement with the at least one movable gripping member thereby blocking the at least one movable gripping member.

15. The torsion spring tensioning tool (100) according to claim 14, wherein the retaining mechanism (310) comprises a biasing arrangement (321) connected to the actuatable mechanism (311) and adapted to bias the actuatable mechanism (311) towards the second position from the first position.

16. The torsion spring tensioning tool (100) according to claim 15, wherein the actuatable mechanism (311) is adjustably movable between the first and second position.

17. The torsion spring tensioning tool (100) according to claim 1, further comprising one or more mounting members (97) for arranging the gear wheel (21) relative the housing (80), the one or more mounting members (97) being adapted to be fix relative to the housing (80).

18. Torsion spring tensioning mechanism (100) according to claim 17, further comprising a first mounting member and second mounting member (97) arranged between the housing (80) and the gear wheel (21) on opposite sides of said gear wheel (21).

19. The torsion spring tensioning tool (100) according to claim 17-OF wherein at least one of the one or more mounting member (97) is releasably mounted to the housing (80) and mountable to the housing (80) in a unblocking position wherein the mounting member (97) is arranged such that the engaging arrangement (32) can be brought into engagement with the shaft (1001) and a blocking position wherein the mounting member (97) is arranged such that the mounting member (97) blocks relative movement between the torsion spring tensioning tool (100) and the shaft (1001) in a direction extending substantially orthogonally to the shaft (1001).

20. The torsion spring tensioning tool (100) according to claim 19, further comprising a releasable bearing mounting (94) adapted to releasably fix the mounting member (97) to the housing (80) in the blocking and/or unblocking position.
